(19) United States
(12) Patent Application Publication
(10) Pub. No.: US 2001/0017105 A1
(43) Pub. Date: Aug. 30, 2001

(54) Wafer plating apparatus

(75) Inventors: Hirofumi Ishida, Atsugi-shi (JP); Yoshiyuki Harima, Tsukui-gun (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: ELECTROPLATING ENGINEERS OF JAPAN LIMITED

(21) Appl. No.: 09/791,841

(22) Filed: Feb. 26, 2001

(30) Foreign Application Priority Data
Feb. 28, 2000 (JP) 2000-50948

(51) Int. Cl. B05C 3/00

(52) U.S. Cl. 118/429

(57) ABSTRACT

The present invention provides a technique for removing air remaining on the peripheral edge of a surface to be plated in a conventional wafer plating apparatus, and to provide a wafer plating apparatus capable of performing a more uniform plating up to the peripheral edge of the surface to be plated, and which is further capable of performing plating even with respect to a wafer coated with a seed metal. This wafer plating apparatus includes a wafer clamp 6 for holding a wafer 4, a wafer support member 7 for supporting the periphery of the surface 5 to be plated of the wafer 4, and a plating tank 2 for circulating a plating solution while making the plating solution overflow from an upper opening of the tank. The wafer plating apparatus is arranged so as to perform plating, while the surface 5 to be plated is laid face down, being in contact with the surface of the plating solution, in a state in which the wafer 4 is clamped by the wafer clamp 6 and the wafer support member 7. In this wafer plating apparatus, the wafer support member 7 is equipped with air-vent holes 12 for discharging air remaining on the peripheral edge of the surface 5 to be plated while the surface of the plating solution and the wafer 4 are made contact with each other.

### BACKGROUND OF THE INVENTION

1. Field of the Invention

The present invention relates to a wafer plating apparatus for plating wafers for use in semiconductors.

2. Description of the Related Art

Hitherto, as a wafer plating apparatus for use in semiconductors, there is known one which performs plating while the wafer surface to be plated is laid face down, being kept in contact with the surface of a plating solution overflowing from a plating tank.

Specifically, as shown in FIG. 5, the above-described wafer plating apparatus includes a wafer clamp 6 for holding a wafer 4 with the surface to be plated 5 of the wafer 4 facing down, a wafer support member 7 capable of supporting the surface to be plated 5 over the entire peripheral edge thereof, and a plating tank 2 capable of circulating a plating solution while making the plating solution overflow from the upper opening thereof. This wafer plating apparatus is arranged so as to perform plating while the surface to be plated 5 is laid face down, being maintained in contact with the surface of the plating solution, in a state in which the wafer 4 is clamped by the wafer clamp 6 and the wafer support member 7.

After the plating has been performed, this wafer plating apparatus withdraws the wafer 4 from the plating solution and rotates the wafer 4 so as to remove the plating solution adhering to the plated surface 5. Therefore, even when a plated film prone to dissolution into the plating solution is formed, there is no risk that the plated film is dissolved by the adhering plating solution while the wafers 4 are exchanged. This results in the plated surface being provided with a superior appearance and the cleaning process in a post-treatment being simplified. Furthermore, this wafer plating apparatus has an advantage in that a uniform plated film can be formed over the entire surface to be plated 5 by rotating the wafer 4 during a plating process.

However, in such a wafer plating apparatus, air contained in the plating solution will remain in a corner portion “C” which is formed by a periphery of a surface to be plated 5 and a wafer support member 7. Since the plating solution flows toward the peripheral directions of the surface to be plated 5, the flowing plating solution is apt to remain in the corner portion C which is a slight step constituted due to a positional relation between the wafer support member 7 and the surface to be plated 5. Accordingly, air contained in the plating solution will also remain in the corner portion “C”. As a result, air liable to remain in the periphery of the surface to be plated will cause non-uniform plating at the corner portion and reduces the plating area, that is, the available area of a wafer. This is undesirable in view of the production yield.

The conventional wafer plating apparatus is arranged so that plating is not started until the air remaining on the surface to be plated is discharged to the outside to some extent, in order to suppress the above-described influence of air. As a result, if plating is conducted on a wafer surface to be plated which has been coated with a metallic film such as Cu, that is, a surface coated with a so-called seed metal, using a plating solution so as to dissolve the seed metal, the seed metal in contact with the plating solution will be dissolved while air is discharged, and consequently, uniform plating may not be performed.

### SUMMARY OF THE INVENTION

It is, therefore, an object of the present invention to provide a technique for removing air remaining on the peripheral edge of the surface to be plated in the conventional wafer plating apparatus, and to provide a wafer plating apparatus capable of performing a more uniform plating up to the peripheral edge of the surface to be plated, and further capable of plating while minimizing the dissolution of the seed metal, even when the wafer is one coated with a seed metal.

To this end, the present invention provides a wafer plating apparatus which comprises a wafer support member having a wafer clamp for holding a wafer with the wafer surface to be plated facing down, and having a wafer support portion which is capable of supporting the surface to be plated over the entire peripheral edge thereof; and a plating tank which circulates a plating solution while making the plating solution overflow from an upper opening of the tank. This wafer plating apparatus is arranged so as to perform plating, while the wafer surface to be plated is laid face down, being maintained in contact with the surface of the plating solution, in a state in which the wafer is clamped by the wafer clamp and the wafer support member. In this wafer plating apparatus, the wafer support member has air-vent holes for discharging the air remaining on the peripheral edge of the surface to be plated while the surface of the plating solution and the wafer are in contact with each other.

According to the present invention, no air will remain at the periphery of the surface to be plated, so that more uniform plating can be applied to larger area than conventional platings, thereby improves the production yield of the wafer. The air-vent hole facilitates discharge of air remaining at the surface to be plated, so that plating operation can be initiated soon after a plating solution is supplied if the surface to be plated of the wafer is covered with seed metal. With this situation, uniform plating can be achieved because dissolution of the seed metal does not progress.

The air-vent hole according to the present invention may be provided at any places of the wafer support member if the places allows air remaining at the periphery of the surface to be plated. Specifically, the hole may be provided at any place close to the corner portion as a positional difference between the wafer support member and the surface to be plated, if air can be discharged.

The air-vent hole according to the present invention can be formed by a through hole made in the wafer support member, for example. The air-vent hole further may be formed by mounting to a lower end of the wafer support member an air-vent-hole-forming ring for forming a hole passing along the outer face of the lower end of the wafer support member through to the periphery of the surface to be plated. If the air-vent-hole-forming ring is applied to the conventional wafer plating apparatus at the wafer support member of the apparatus, no through holes need not be made in the wafer support member to provide wafer plating apparatus.

It is preferable to provide the wafer plating apparatus according to the present invention with a forcible discharge means at the air-vent hole of the apparatus in order to remove air more efficiently. The forcible discharge means when mounted to the discharge side of the air-vent hole enables air remaining at the periphery of the surface to be plated to be removed efficiently.

### BRIEF DESCRIPTION OF THE DRAWINGS

FIG. 1 is a schematic sectional view showing a wafer plating apparatus in accordance with a first embodiment;

FIG. 2 is a partially enlarged sectional view showing the wafer plating apparatus in accordance with the first embodiment;

FIG. 3 is a partially enlarged sectional view showing a wafer plating apparatus in accordance with a second embodiment;

FIG. 4 is a partially enlarged sectional view showing a wafer plating apparatus in accordance with a third embodiment; and

FIG. 5 is a schematic sectional view showing a conventional wafer plating apparatus.

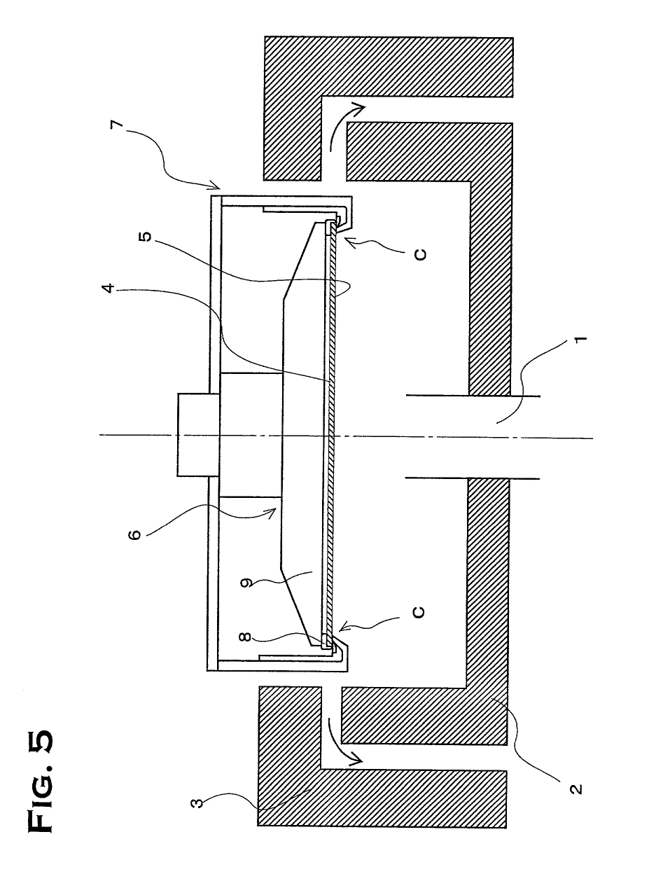

### DESCRIPTION OF THE PREFERRED EMBODIMENTS

Hereinafter, the preferred embodiments of the wafer plating apparatus according to the present invention will be described.

First Embodiment

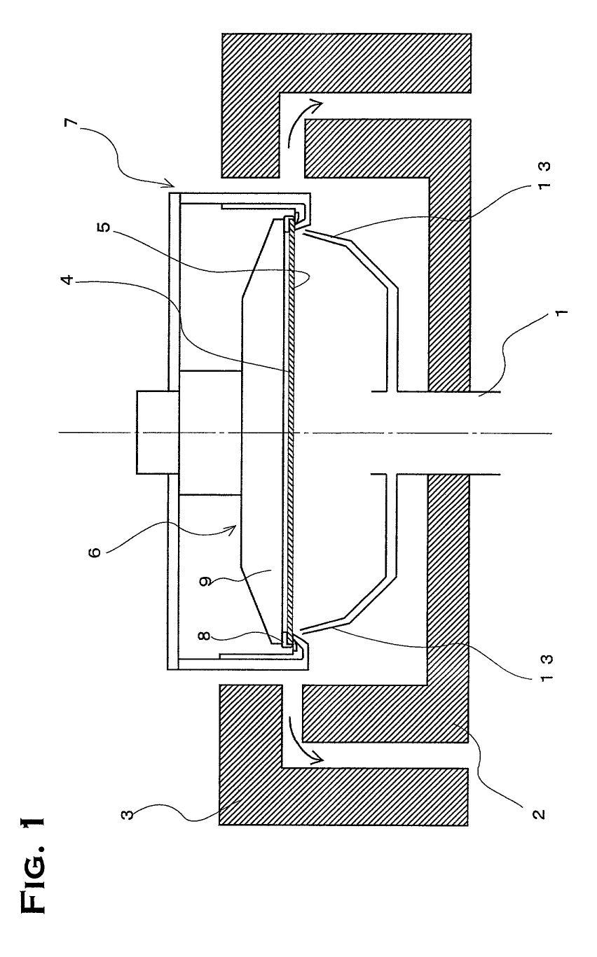

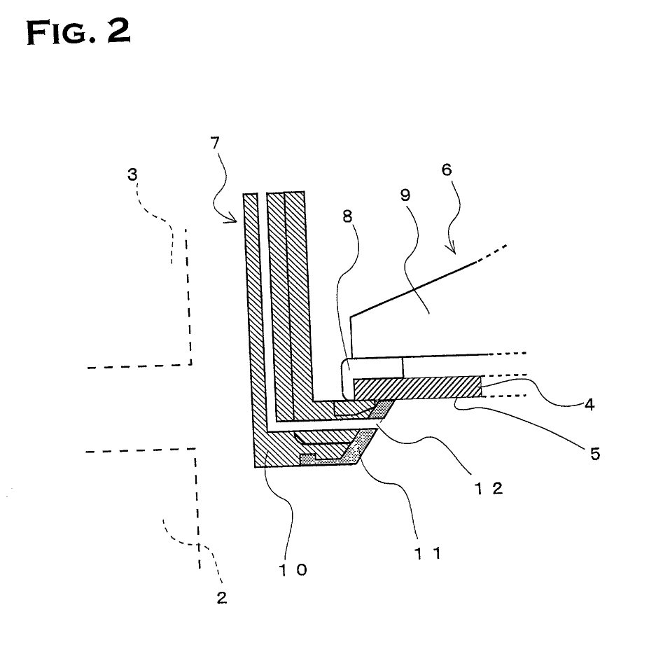

FIG. 1 shows a schematic sectional view illustrating a first embodiment of a wafer plating apparatus according to the present invention. FIG. 2 shows a partially enlarged view of FIG. 1. As shown in FIG. 1, the wafer plating apparatus in accordance with the first embodiment has a plating tank 2 supplying a plating solution through a supply pipe 1 and overflowing the plating solution from an upper opening, and has an outer tank 3 surrounding the plating tank 2 and circulating the plating solution overflowing from the plating tank 2. The wafer plating apparatus is further provided with: a wafer clamp 6 capable of holding the wafer 4 with the surface 5 to be plated facing down so as to opposed to the overflowing plating solution; and a wafer support member 7 capable of supporting the surface to be plated 5 of the wafer 4 over the entire peripherry thereof.

Both the wafer clamp 6 and the wafer support member 7 are vertically movable, and are horizontally rotatable while supporting the wafer 4. As shown in FIG. 2, the wafer clamp 6 is formed of a clamp seal 8 for holding the side peripheral surface of the wafer 4, and a clamp body 9. The wafer support member 7 is formed of a wafer support portion 10 having an L-shaped cross-section and a liquid seal 11 provided on the inner peripheral surface side of the support portion.

As shown the enlarged view in FIG. 2, air-vent means according to the first embodiment is provided in a manner that it passes through the inside of the wafer support member 7. An air-vent hole 12 passes the liquid seal 11 at an area near the surface to be plated 5 through the wafer support portion 10, and is provided at a plural places on the entire periphery of the surface to be plated 5. An exhaust pump not shown is connected to the air-vent hole 12 so as to allow air to be forcibly discharged via the air-vent hole 12.

Also, a solution-supply nozzle 13 is disposed in the plating tank 2, the solution-supply nozzle being capable of supplying the plating solution to the peripheral edge of the surface to be plated 5. Supplying the plating solution through the solution-supply nozzle 14 to the surface to be plated 5 facilitates the discharge of air from the air-vent hole 12.

Second Embodiment

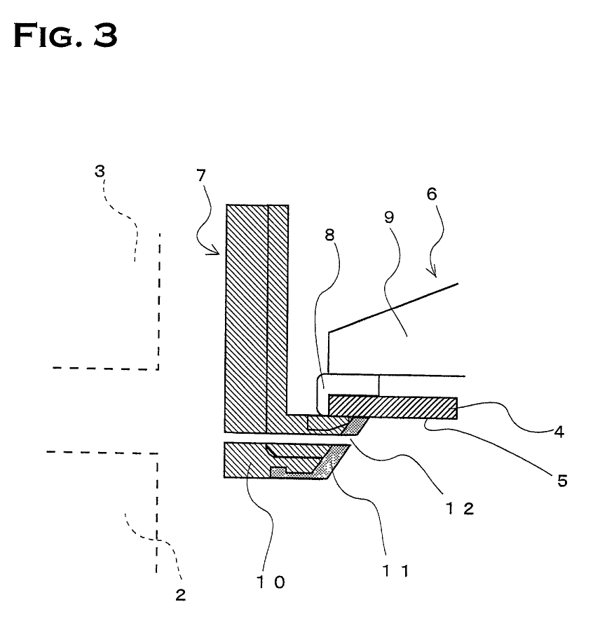

Next, a second embodiment is described. FIG. 3 shows a wafer plating apparatus having an air-vent means according to the second embodiment. Descriptions about the other sections such as the plating tank 2, outer tank 3, solution-supply nozzle 13 and the like are omitted because they have already been descibed in the first embodiment. As FIG. 3 shows, the air-vent hole 12 according to the second embodiment is formed so as to pass thorough a wafer support portion 10 of a wafer support member 7 and a liquid seal 11. Similarly in the air-vent hole 12 according to the second embodiment, a plating solution supplied through the solution-supply nozzle 13 toward the periphery of the surface 5 to be plated will pass through the air-vent hole 12 and be discharged to the outer periphery side of the wafer support member 7. With the discharge, remaining air will be also removed. When the wafer 4 is rotated during a plating operation, plating solution will pass through the air-vent hole 12 according to the second embodiment, and air will also move to the outside of the wafer support portion 10, so that air can be removed from the periphery of the surface 5 to be plated.

Third Embodiment

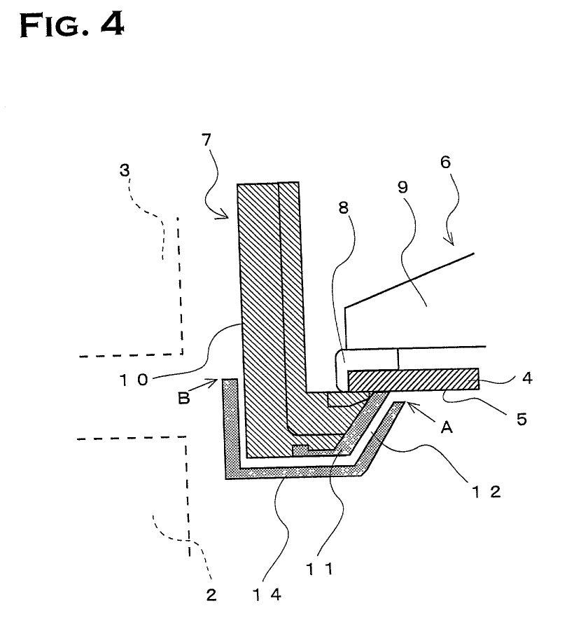

Next, a third embodiment is described. FIG. 4 shows a wafer plating apparatus having an air-vent means according to the third embodiment. Descriptions about the other sections such as the plating tank 2, outer tank 3, solution-supply nozzle 13 and the like are omitted because they have already been descibed in the first embodiment. As FIG. 4 shows, the air-vent hole 12 according to the third embodiment is formed by mounting an air-vent-hole-forming ring 14 to a wafer support member 7.

The air-vent-hole-forming ring 14 has a cross section similar to the contour of the lower end of the wafer support portion 10 in terms of the L-shape in cross section of the portion 10. The air-vent-hole-forming ring 14 has been shaped to cover a part of an outer face of the lowwer end of the wafer support portion at the entire periphery of the wafer support portion 10, and further has been shaped to provide a gap with respect to the wafer support portion 10. The air-vent-hole-forming ring 14, once mounted, will provide the periphery of the surface 5 to be plated with a slit-like air-vent hole to allow air to be removed.

Removal of air can be efficiently carried out with a rotation of wafer 4 which is clamped by the wafer clamp 6 and the wafer support member 7. This is because rotation of wafer 4 allows a plating solution in the slit-like air-vent hole to be discharged from the air-vent hole by centrifugal force, and air is simultaneously removed with the plating solution being discharged.

It is important regarding the air-vent-hole-forming ring 14 to position the section as shown by an arrow “A” higher than that as shown by an arrow “B”. An air-vent hole 12 formed with such a positional relationship between “A” and “B” facilitates air removal due to a difference in solution pressure caused by the difference in height between “A” and “B”.

Each of the above-described wafer plating apparatuss according to the present invention eliminates non-uniform plating caused by air on the peripheral edge of the surface to be plated, allows more uniform plating up to the peripheral edge of the surface to be plated to be performed, and improves the production yield of the wafer. Furthermore, even when a wafer with a seed metal is plated with a plating which is likely to dissolve the seed metal, the dissolution of the seed metal can be minimized, and hence, a relatively uniform plating can be realized.

What is claimed is:

1. A wafer plating apparatus comprising:
a wafer support member having a wafer clamp for holding a wafer with the wafer surface to be plated facing down, and having a wafer support portion which has an L-shaped cross-section and which is capable of supporting the surface to be plated over its entire peripheral edge; and
a plating tank in which a plating solution is circulated while the plating solution is made to overflow from an upper opening of the tank,
said wafer plating apparatus performing plating, while the wafer surface to be plated is laid face down, being maintained kept in contact with the surface of the plating solution, in a state in which the wafer is clamped by the wafer clamp and the wafer support member,
wherein the wafer support member has air-vent holes for discharging air remaining on the periphery of the surface to be plated while the surface of the plating solution and the wafer are in contact with each other, the air-vent holes being formed at the lower end of the wafer support portion.

2. A wafer plating apparatus according to claim 1, wherein the air-vent holes are formed by mounting to a lower end of the wafer support member an air-vent-hole-forming ring for forming a hole passing along the outer face of the lower end of the wafer support member through to the periphery of the surface to be plated.

3. A wafer plating apparatus according to claim 1, wherein the air-vent holes are provided with a forcible discharge means.

4. A wafer plating apparatus according to claim 2, wherein the air-vent holes are provided with a forcible discharge means.

5. A wafer plating apparatus according to claim 1, wherein a solution-supply nozzle is provided in a plating tank, the solution-supply nozzle forcibly supplying the plating solution to the peripheral edge of the surface to be plated.

6. A wafer plating apparatus according to claim 2, wherein a solution-supply nozzle is provided in a plating tank, the solution-supply nozzle forcibly supplying the plating solution to the peripheral edge of the surface to be plated.

7. A wafer plating apparatus according to claim 3, wherein a solution-supply nozzle is provided in a plating tank, the solution-supply nozzle forcibly supplying the plating solution to the peripheral edge of the surface to be plated.
